(19) United States
(12) Patent Application Publication
(10) Pub. No.: US 2014/0188929 A1
(43) Pub. Date: Jul. 3, 2014

(54) COMPUTER-READABLE STORAGE MEDIUM, FILE MANAGEMENT APPARATUS, AND FILE MANAGEMENT METHOD

(71) Applicants: HONDA MOTOR CO., LTD., TOKYO (JP); FUJITSU LIMITED, KAWASAKI-SHI (JP)

(72) Inventors: KAZUHISA HANAMOTO, KAWASAKI (JP); MASAYUKI OKISHIO, UTSUNOMIYA (JP); YASUO KUROSAKI, WAKO (JP); HIROSHI ISHIDA, WAKO (JP)

(73) Assignees: HONDA MOTOR CO., LTD., TOYKO (JP); FUJITSU LIMITED, KAWASAKI-SHI (JP)

(21) Appl. No.: 14/140,235

(22) Filed: Dec. 24, 2013

(30) Foreign Application Priority Data
Dec. 28, 2012 (JP) 2012-289101

(51) Int. Cl. G06F 17/30

(52) U.S. Cl. CPC G06F 17/30106
USPC 707/769

(57) ABSTRACT

A storage unit stores therein an association relationship between information for specifying a first portion of a file in a first table format and information for specifying a second portion of a file in a second table format. The control unit extracts, upon receiving a search request for an area to be influenced by the first portion, the information for specifying the second portion associated with the information for specifying the first portion by referring to the storage unit, and outputs the information for specifying the second portion and information for specifying the file in the second table format containing the second portion, as a reply to the search request.

### CROSS-REFERENCE TO RELATED APPLICATIONS

This application is based upon and claims the benefit of priority of the prior Japanese Patent Application No. 2012-289101, filed on Dec. 28, 2012, the entire contents of which are incorporated herein by reference.

### FIELD

The embodiments discussed herein are directed to a file management program, a file management apparatus, and a file management method.

### BACKGROUND

In product design and development, various documents, such as specification documents, design documents, or test specification documents, generated through design and development processes are managed. Examples of the product include a control system and an embedded system in the automobile industry, the electronics/precision industry, or the like. Therefore, in the product design and development, in some cases, a file management apparatus manages a large number of documents.

The file management apparatus can store information on association between files through a file association process performed by an operator. In this configuration, when one of the files is modified, the file management apparatus can search for a file influenced by the modification.
Patent Literature 1: Japanese Laid-open Patent Publication No. 2005-135221

However, the file management apparatus associates the files on a file-by-file basis. Therefore, it is difficult to specify what portion of a file is to be influenced by a modification.

Therefore, the operator determines a portion to be influenced in the entire file by referring to descriptions in the file. Consequently, if the amount of the descriptions is large, it takes more effort and time to specify an area to be influenced.

### SUMMARY

According to an aspect of the present invention, non-transitory computer-readable recording medium having stored therein a file management program for causing a computer to execute a process, the process includes extracting, upon receiving a search request for an area to be influenced by a first portion of a file in a first table format, information for specifying a second portion of a file in a second table format associated with information for specifying the first portion, by referring to a storage unit containing an association relationship between the information for specifying the first portion and the information for specifying the second portion; and outputting the information for specifying the second portion and information for specifying the file in the second table format containing the second portion, as a reply to the search request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a schematic configuration of an entire system including a file management apparatus;

FIG. 2 is a diagram illustrating an overall configuration of the file management apparatus;

FIG. 3 is a diagram illustrating an example of a data structure of format information;

FIG. 4 is a diagram illustrating an example of a data structure of element information;

FIG. 5 is a diagram illustrating an example of a data structure of file information;

FIG. 6 is a diagram illustrating an example of a data structure of relation information;

FIG. 7 is a diagram illustrating an example of the flow to extract attribute information and information on an element corresponding to the attribute information;

FIG. 8 is a diagram illustrating an example of the flow to associate elements of documents;

FIG. 9 is a diagram illustrating an example of a designation screen;

FIG. 10 is a diagram illustrating an example of association between various documents;

FIG. 11 is a diagram illustrating an example of a condition screen;

FIG. 12 is a diagram illustrating an example of the flow to search for an area to be influenced;

FIG. 13 is a flowchart illustrating the flow of an extraction process;

FIG. 14 is a flowchart illustrating the flow of an association process;

FIG. 15 is a flowchart illustrating the flow of a search process;

FIG. 16 is a diagram illustrating an example of a data structure of relation information;

FIG. 17 is a diagram illustrating an example of the designation screen;

FIG. 18 is a diagram illustrating an example of an operation screen;

FIG. 19 is a diagram illustrating an example of the condition screen;

FIG. 20 is a flowchart illustrating the flow of a search process; and

FIG. 21 is a diagram illustrating a computer that executes a file management program.

### DESCRIPTION OF EMBODIMENTS

Preferred embodiments of the present invention will be explained with reference to accompanying drawings. The present invention is not limited to the embodiments below. The embodiments may be combined appropriately as long as the processes do not conflict with one another.

### [a] First Embodiment

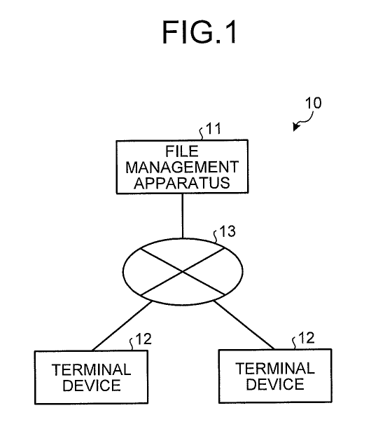

A system according to a first embodiment will be explained. FIG. 1 is a diagram illustrating an example of a schematic configuration of an entire system including a file management apparatus. As illustrated in FIG. 1, a system 10 includes a file management apparatus 11 and terminal devices 12. The file management apparatus 11 and the terminal devices 12 can exchange various types of information with one another. For example, the file management apparatus 11 and the terminal devices 12 are connected to one another via a network 13 in a communicable manner, and can exchange various types of information with one another. The network 13 may be any communication network, such as a local area network (LAN) or a virtual private network (VPN), regardless of whether it is wired or wireless. In the example in FIG. 1, the system 10 includes the two terminal devices 12; however, the disclosed system is not limited to this example and may include an arbitrary number of the terminal devices 12.

The terminal devices 12 are computers used by developers who perform development. The terminal devices 12 are, for example, information processing apparatuses such as desktop personal computers (PC), tablet PCs, or notebook PCs. A developer generates various documents by the terminal devices 12 during the development. For example, the developer generates various documents, such as a functional requirement document for describing requirements for functions needed for the development, a functional design document for designing each of the functions, and a test specification document for testing whether each of the functions is realized, according to each stage of the development. In the documents generated through the development as described above, contents to be described, written portions, styles, and the like are determined for each of specific categories, such as a document type, a development timing, and a development agent, to unify a description format. By unifying the description format for each type of a document, all of the documents of the same type can contain the same items; therefore, it becomes possible to prevent omission of an item that needs to be described. Furthermore, by unifying the description format for each type of a document, it becomes possible to promptly refer to a target written portion when checking the contents of the documents of the same type; therefore, it becomes possible to easily check the contents. The developer generates the documents according to document formats by using software that enables to generate a document in a table format. Examples of the software that enables to generate a document in a table format include spreadsheet software such as Microsoft Excel (registered trademark). Incidentally, the development includes not only software development but also hardware development. For example, in the development of an automobile, hardware development and software development are performed in order to realize needed functions. Furthermore, each of the documents may be generated by using a document of related development. For example, in the development of an automobile, if a new car model is developed by using or modifying a certain component of an already-developed car model, a document of the new car model is generated by using a document of the component of the already-developed car model.

The file management apparatus 11 manages a file of a document. The file management apparatus 11 is, for example, a computer such as a server computer. The file management apparatus 11 may be implemented by a single computer or a cloud computing including multiple computers. In the first embodiment, an example is explained in which the file management apparatus 11 is implemented by a single computer. The file management apparatus 11 can manage documents by classifying the documents into groups. For example, the file management apparatus 11 manages documents by classifying the documents for each development process. The file management apparatus 11 provides separate folders to receive registration of documents for the respective groups, and receives registration of documents from the terminal device 12. When a developer generates or modifies a document by the terminal device 12, he/she registers a file of the document in a table format in a folder corresponding to the type of the document. When a file of a new document is registered in the folder, the file management apparatus 11 stores the registered file of the document. Furthermore, when an already-registered document is newly registered in the folder, the file management apparatus 11 compares the already-registered document and the newly-registered document to specify a modified portion and modified contents. Then, the file management apparatus 11 stores, as a modification history, the modified portion and the modified contents specified as above, together with the newly-registered document.

The file management apparatus 11 determines a relevance between the files of the registered documents. As a result of the determination, the file management apparatus 11 manages the files containing related portions, in an associated manner.

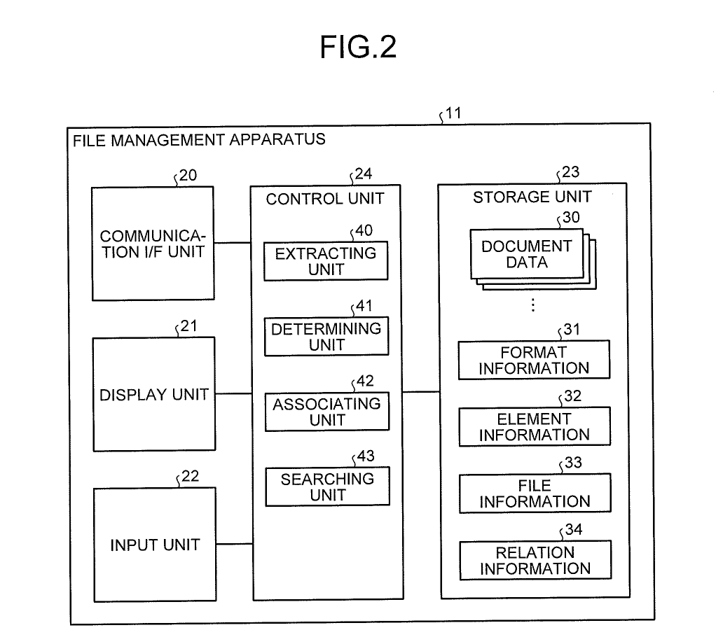

The file management apparatus 11 according to the first embodiment will be explained below. FIG. 2 is a diagram illustrating an overall configuration of the file management apparatus. As illustrated in FIG. 2, the file management apparatus 11 includes a communication interface (I/F) unit 20, a display unit 21, an input unit 22, a storage unit 23, and a control unit 24.

The communication I/F unit 20 is an interface for controlling communication with other devices, such as the terminal devices 12. The communication I/F unit 20 transmits and receives various types of information to and from the other devices via the network 13. For example, the communication I/F unit 20 receives a file of a document in a table format from the terminal device 12 via the network 13. As an example of the communication I/F unit 20, a network interface card, such as a LAN card, may be employed.

The display unit 21 is a display device that displays various types of information. Examples of the display device serving as the display unit 21 include a liquid crystal display (LCD) and a cathode ray tube (CRT). The display unit 21 displays various types of information.

The input unit 22 is an input device that inputs various types of information. Examples of the input device serving as the input unit 22 include a mouse and a keyboard. The input unit 22 receives input of operation from a user, and inputs operation information indicating the contents of the received operation to the control unit 24.

The storage unit 23 is a storage device, such as a hard disk, a solid state drive (SSD), or an optical disk. The storage unit 23 may be a data-rewritable semiconductor memory, such as a random access memory (RAM), a flash memory, or a non-volatile static random access memory (NVSRAM).

The storage unit 23 stores therein an operating system (OS) and various programs used for file management, which are executed by the control unit 24. Furthermore, the storage unit 23 stores therein various types of data used in the programs executed by the control unit 24. For example, the storage unit 23 stores therein document data 30, format information 31, element information 32, file information 33, and relation information 34.

The document data 30 is data of a file of a registered document. For example, the document data 30 is stored when the terminal device 12 registers a file of a document in a document registration folder. Furthermore, the document data 30 is referred to by an extracting unit 40 (to be described later) when an element in the document is to be extracted.

The format information 31 is data, in which information on an element to be associated in a file in a table format is stored for each of description formats of documents. Incidentally, in a design process of the development, a requirement needed for the development is determined and a function for concretely realizing the requirement is designed. Then, in a test process, a test is performed to check whether the designed function is implemented and whether the requirement needed for the function is satisfied. As described above, in some cases, the requirement, the function, and the test item are related with one another. When there is the relevance, if any one of the related portions is modified, the other related portions may also be modified. For example, if the requirement is modified, a function related to the modified requirement and a test item related to the modified requirement are also modified. Therefore, the file management apparatus 11 according to the first embodiment stores, in the format information 31, information on a cell containing information on an element to be associated, for each of description formats of documents. For example, the format information 31 is registered by a developer who generates a document or an administrator who manages the file management apparatus 11 via the input unit 22 or the terminal device 12. Furthermore, the format information 31 is referred to by the extracting unit 40 (to be described later) in order to extract an element to be associated.

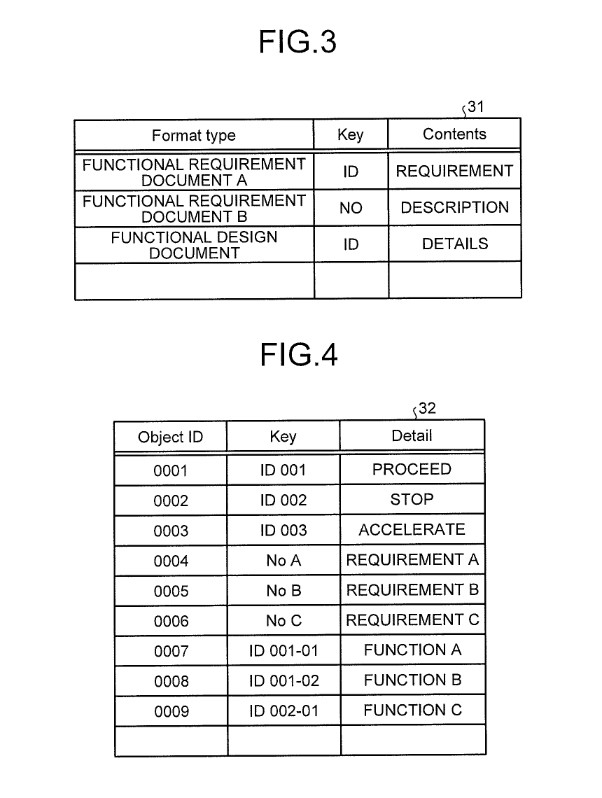

FIG. 3 is a diagram illustrating an example of a data structure of the format information. As illustrated in FIG. 3, the format information 31 contains items of “Format type”, “Key”, and “Contents”. The item of Format type is a field for storing a type of a description format of a document. In the first embodiment, in the item of Format type, a name indicating a type of a document generated in a corresponding format is stored as the type of the description format. The item of Key is a field for storing an item name of attribute information added to an element in the document. For example, in the document, attribute information, such as an identification (ID) and a number (No), for identifying an element is added to the element to write a requirement. In the item of Key, an item name of the attribute information contained in a document generated in a corresponding format is stored. The item of Contents is a field for storing an item name of a cell containing information on an element in the document. For example, in the document, an item for writing information on an element is provided and processing contents or the like is written in association with the attribute information. In the item of Contents, an item name of a portion where the information on the element is written is stored.

In the example in FIG. 3, a document of “functional requirement document A” has “ID” as the item name of the attribute information and “requirement” as the item name of the item where the information on the element is written. Furthermore, a document of “functional requirement document B” has “No” as the item name of the attribute information and “Description” as the item name of the item where the information on the element is written. Moreover, a document of “functional design document” has “ID” as the item name of the attribute information and “contents” as the item name of the item where the information on the element is written.

The element information 32 is data containing information on an element extracted from a document. For example, the element information 32 is stored by the extracting unit 40 (to be described later). Furthermore, the element information 32 is referred to by the extracting unit 40 (to be described later) in order to determine a related element.

FIG. 4 is a diagram illustrating an example of a data structure of the element information. As illustrated in FIG. 4, the element information 32 contains items of “Object ID”, “Key”, and “Detail”. The item of Object ID is a field for storing identification information added to an extracted element. In the first embodiment, a unique ID number is assigned, as the identification information, to an element extracted from a document. Incidentally, if the same document as the registered document has already been registered, and the same information of Key as the information of Key of the element extracted from the registered document has already been registered in the element information 32, the same ID number is added to the element. In the item of Object ID, the assigned ID number is stored. The item of Key is a field for storing attribute information extracted from the document. As described above, in the document, the attribute information, such as an ID or a No, is added to the elements. In the item of Key, the attribute information extracted from the document is stored. The item of Detail is a field for storing information on an element extracted from the document. As described above, in the document, the information on the element is written in association with the attribute information. In the item of Detail, information on the extracted element is stored.

In the example in FIG. 4, an Object ID of “0001” indicates that attribute information of “ID 001” and an element of “proceed” are extracted. Furthermore, an Object ID of “0004” indicates that attribute information of “No A” and an element of “requirement A” are extracted. Moreover, an Object ID of “0007” indicates that attribute information of “No 001-01” and an element of “function A” are extracted.

The file information 33 is data containing information on a file from which an element is extracted. For example, the file information 33 is stored by the extracting unit 40 (to be described later). Furthermore, the file information 33 is referred to by a searching unit 43 (to be described later) in order to specify a file to be influenced.

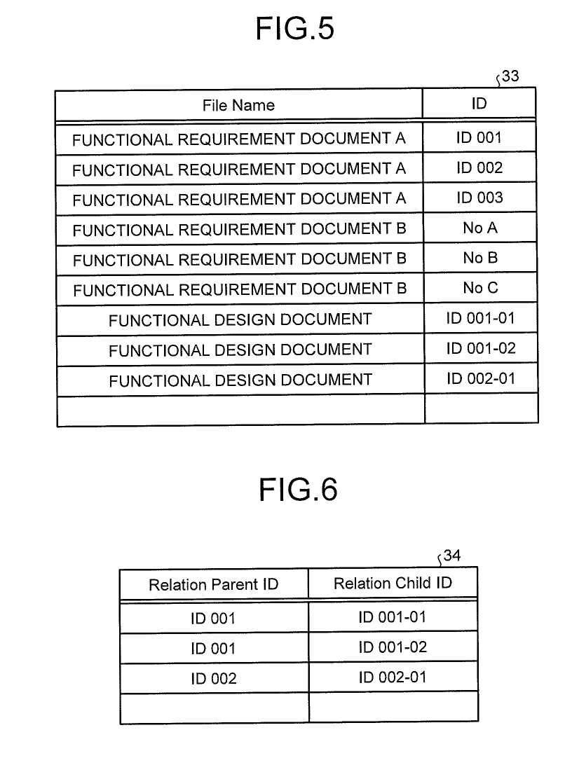

FIG. 5 is a diagram illustrating an example of a data structure of the file information. As illustrated in FIG. 5, the file information 33 contains items of “File Name” and “ID”. The item of File Name is a field for storing information indicating a file from which an element is extracted. In the first embodiment, in the item of File Name, a name of a document from which an element is extracted is stored as the information indicating the file. The item of ID is a field for storing information for identifying the extracted element. In the first embodiment, attribute information on the extracted element is stored in the item of ID. Incidentally, it may be possible to store an ID number assigned to the extracted element in the item of ID.

In the example in FIG. 5, it is indicated that an ID of “ID 001” is extracted from the document of “functional requirement document A”. Furthermore, it is indicated that an ID of “No A” is extracted from the document of “functional requirement document B”. Moreover, it is indicated that an ID of “No 001-01” is extracted from the document of “functional design document”.

The relation information 34 is data containing information on an associated element. For example, the relation information 34 is stored by an associating unit 42 (to be described later). Furthermore, the relation information 34 is referred to by the searching unit 43 (to be described later) in order to specify an area to be influenced.

FIG. 6 is a diagram illustrating an example of a data structure of the relation information. As illustrated in FIG. 6, the relation information 34 contains items of “Relation Parent ID” and “Relation Child ID”. The item of Relation Parent ID is a field for storing information indicating one of associated elements. The item of Relation Child ID is a field for storing information indicating the other one of the associated elements. In the first embodiment, respective pieces of attribute information on the elements are stored in the items of Relation Parent ID and Relation Child ID. Incidentally, it may be possible to store respective ID numbers assigned to the elements in the items of Relation Parent ID and Relation Child ID. In the first embodiment, it is possible to determine a dependency relationship when associating the elements. In the item of Relation Parent ID, attribute information on a superordinate element in the dependency relationship is stored. In the item of Relation Child ID, attribute information on a subordinate element in the dependency relationship is stored.

In the example in FIG. 6, an element of “ID 001” and an element of “ID 001-01” are associated with each other, where the element of “ID 001” is a superordinate element and the element of “ID 001-01” is a subordinate element. Furthermore, the element of “ID 001” and an element of “ID 001-02” are associated with each other, where the element of “ID 001” is a superordinate element and the element of “ID 001-02” is a subordinate element. Moreover, an element of “ID 002” and an element of “ID 002-01” are associated with each other, where the element of “ID 002” is a superordinate element and the element of “ID 002-01” is a subordinate element.

Referring back to FIG. 2, the control unit 24 is a device that controls the file management apparatus 11. As the control unit 24, an electronic circuit, such as a central processing unit (CPU) or a micro processing unit (MPU), or an integrated circuit, such as an application specific integrated circuit (ASIC) or a field programmable gate array (FPGA), may be employed. The control unit 24 includes an internal memory for storing programs that define flows of various processes or for storing control data, and performs various processes with the programs and data. The control unit 24 functions as various processing units by executing various programs. For example, the control unit 24 includes the extracting unit 40, a determining unit 41, the associating unit 42, and the searching unit 43.

The extracting unit 40 extracts various types of information. For example, when a file of a document in a table format is registered in a folder for receiving registration of the document, the extracting unit 40 extracts an element from the table-format file according to a format of the document by referring to the format information 31. If the file contains information indicating a type of the document, the format of the document may be determined based on the information contained in the file. For example, if information indicating a description format of the document is contained in a file name of the file or in a specific cell, the extracting unit 40 specifies the description format based on the registered file. For example, if a name indicating the type of the document is contained in the file name of the file or in a specific cell, the extracting unit 40 specifies the description format based on the file name or the specific cell. Incidentally, the description format of the document may be designated by a developer. For example, if a file is registered in a folder for receiving registration of the document, the extracting unit 40 displays types of description formats of documents stored in the format information 31 onto the terminal device 12, and receives designation of a description format.

The extracting unit 40 obtains, from the format information 31, a portion where an element to be associated is extracted, based on the description format of the document. For example, the extracting unit 40 obtains an item name of attribute information to be extracted and an item name of a cell containing information on an element, by referring to the items of Key and Contents in the format information 31. Then, the extracting unit 40 searches for cells with the obtained item name in the registered file, and sequentially extracts pieces of data of the cells with the item names along a column. The data extraction is continued until a predetermined termination condition is satisfied. For example, the termination condition may be set such that the data extraction is terminated when a predetermined number of empty cells are continued. Furthermore, the termination condition may be set such that the data extraction is terminated when data extraction for a predetermined number of cells is completed. It may be possible to provide a single termination condition for all of the documents, or provide different termination conditions for different types of the documents.

The extracting unit 40 assigns a unique ID number to the extracted attribute information and the extracted information on the element corresponding to the attribute information, and stores the ID number in association with the attribute information and the information on the element corresponding to the attribute information in the element information 32. Furthermore, the extracting unit 40 stores the attribute information and a document name of a file from which the element is extracted, in the file information 33 in an associated manner.

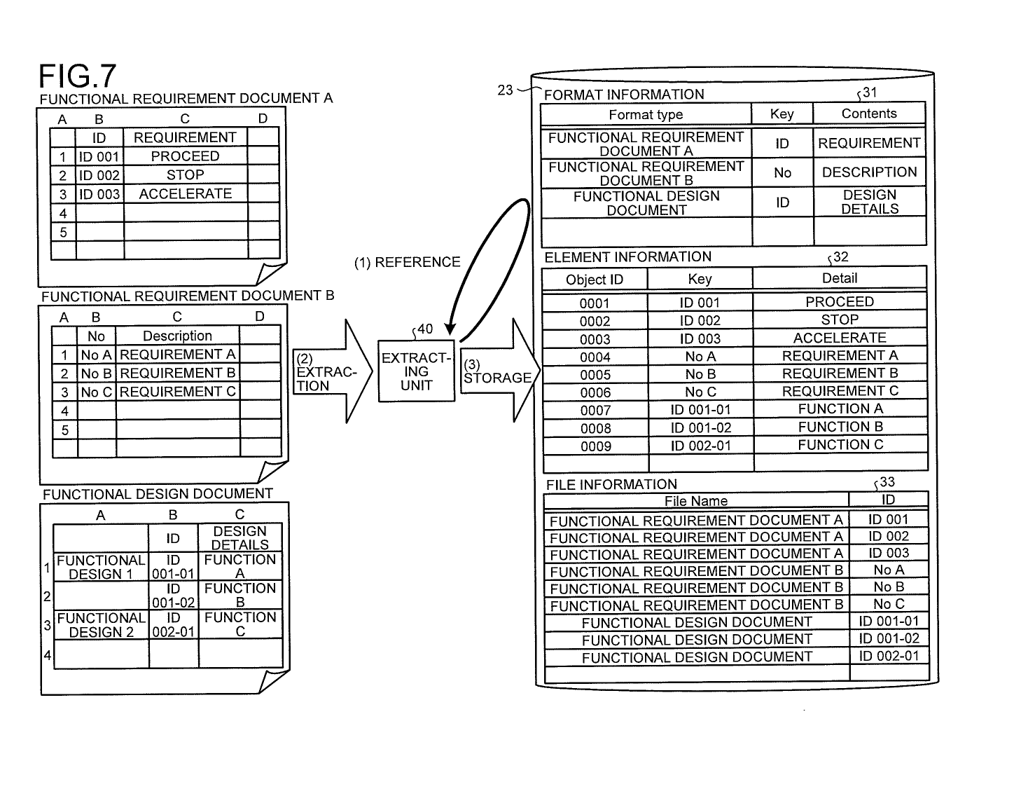

FIG. 7 is a diagram illustrating an example of the flow to extract the attribute information and the information on the element corresponding to the attribute information. When a file of a document in a table format is registered, the extracting unit 40 specifies an item name of an item to be extracted, by referring to the format information 31. For example, as illustrated in FIG. 7, when the functional requirement document A is registered, the extracting unit 40 specifies the items of “ID” and “requirement” as extraction objects by referring to the format information 31. Furthermore, when the functional requirement document B is registered, the extracting unit 40 specifies the items of “No” and “Description” as extraction objects by referring to the format information 31. Moreover, when the functional design document is registered, the extracting unit 40 specifies the items of “ID” and “design details” as extraction objects by referring to the format information 31.

Subsequently, the extracting unit 40 extracts pieces of data of the items with the item names specified as the extraction objects from the registered files. In the example in FIG. 7, the extracting unit 40 extracts pieces of data of the items of “ID” and “requirement” from the functional requirement document A. Furthermore, the extracting unit 40 extracts pieces of data of the items of “No” and “Description” from the functional requirement document B. Moreover, the extracting unit 40 extracts pieces of data of the items of “ID” and “design details” from the functional design document. As described above, the extracting unit 40 extracts pieces of data of items with the item names specified as the extraction objects from the registered files. Consequently, the extracting unit 40 can extract data regardless of a written position of the data as long as the registered document contains the data of the item with the item name specified as the extraction object. Namely, the extracting unit 40 can extract the data of the item being the extraction object even when the position of a cell of the data of the item being the extraction object is not fixed in the document.

The extracting unit 40 assigns a unique ID number to the extracted attribute information and the extracted information on the element corresponding to the attribute information, and stores the ID number in association with the attribute information and the information on the element corresponding to the attribute information in the element information 32. Furthermore, the extracting unit 40 stores the attribute information and the document name of the file from which the element has been extracted, in the file information 33 in an associated manner. Therefore, in the example in FIG. 7, the items of “ID 001” and “proceed” are extracted from the functional requirement document A, and the ID number of “0001” is assigned to the extracted items. Subsequently, the items of “0001”, “ID 001”, and “proceed” are stored in the element information 32 in an associated manner. Then, the items of “functional requirement document A” and “ID 001” are stored in the file information 33 in an associated manner. Furthermore, the items of “No A” and “requirement A” are extracted from the functional requirement document B, and the ID number of “0004” is assigned to the extracted items. Subsequently, the items of “0004”, “No A”, and “requirement A” are stored in the element information 32 in an associated manner. Then, the items of “functional requirement document B” and “No A” are stored in the file information 33 in an associated manner. Moreover, the items of “ID 001-01” and “function A” are extracted from the functional design document, and the ID number of “0007” is assigned to the extracted items. Subsequently, the items of “0007”, “ID 001-01”, and “function A” are stored in the element information 32 in an associated manner. Then, the items of “functional design document” and “ID 001-01” are stored in the file information 33 in an associated manner. Incidentally, it may be possible to store ID numbers in the item of ID in the file information 33.

Referring back to FIG. 2, the determining unit 41 performs various types of determination. For example, the determining unit 41 refers to the element information 32 and compares pieces of information stored in the element information 32, to thereby determine a relevance between files. For example, the determining unit 41 reads pieces of information stored in the item of Key from the element information 32. Then, the determining unit 41 compares each of the read pieces of the information with the other read pieces of the information to determine whether the pieces of the information entirely or partially match each other. If the pieces of the information entirely or partially match each other, the determining unit 41 determines that there is a relevance. Incidentally, for example, the determining unit 41 may read pieces of information stored in the item of Detail from the element information 32, and compare each of the read pieces of the information with the other read pieces of the information to determine a relevance. Furthermore, the determining unit 41 may compare the pieces of the information in the items of Key and Detail, and, if the pieces of the information in each of the items of Key and Detail entirely or partially match each other, the determining unit 41 may determine that there is a relevance.

The associating unit 42 makes various types of association. For example, the associating unit 42 associates elements that are determined as related elements by the determining unit 41. For example, the associating unit 42 reads, from the element information 32, pieces of information in the item of Key of the elements determined as related elements, and registers the read pieces of the information on the related elements in the relation information 34 in an associated manner.

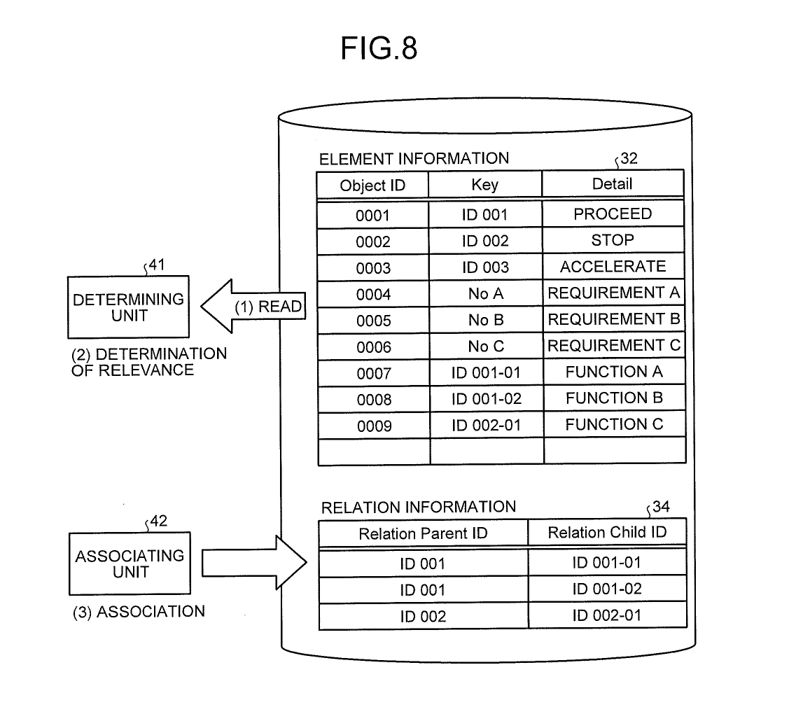

FIG. 8 is a diagram illustrating an example of the flow to associate elements of documents. The determining unit 41 reads pieces of information stored in the item of Key from the element information 32. In the example in FIG. 8, “ID 001”, “ID 002”, “ID 003”, “No A”, “No B”, “No C”, “ID 001-01”, “ID 001-02”, and “ID 002-01” stored in the item of Key are read. The determining unit 41 compares each of the read pieces of the information with the other read pieces of the information to determine whether the pieces of the information entirely or partially match each other. In the example in FIG. 8, “ID 001” and “ID 001-01” partially match each other, “ID 001” and “ID 001-02” partially match each other, and “ID 002” and “ID 002-01” partially match each other; therefore, it is determined that the pieces of the information are related to each other. The associating unit 42 reads the pieces of the information stored in the item of Key of the elements determined as the related elements, and registers the piece of the information on the related elements in the relation information 34 in an associated manner. Specifically, in the example in FIG. 8, “ID 001” and “ID 001-01”, “ID 001” and “ID 001-02”, and “ID 002” and “ID 002-01” are registered in the relation information 34 in an associated manner. Incidentally, when associating the pieces of the information, the associating unit 42 may store ID numbers of the elements to be associated in the items of Relation Parent ID and Relation Child in the relation information 34. Alternatively, the associating unit 42 may display the elements determined as related elements, display a designation screen for receiving designation of elements to be associated with each other, and associate the elements designated via the designation screen.

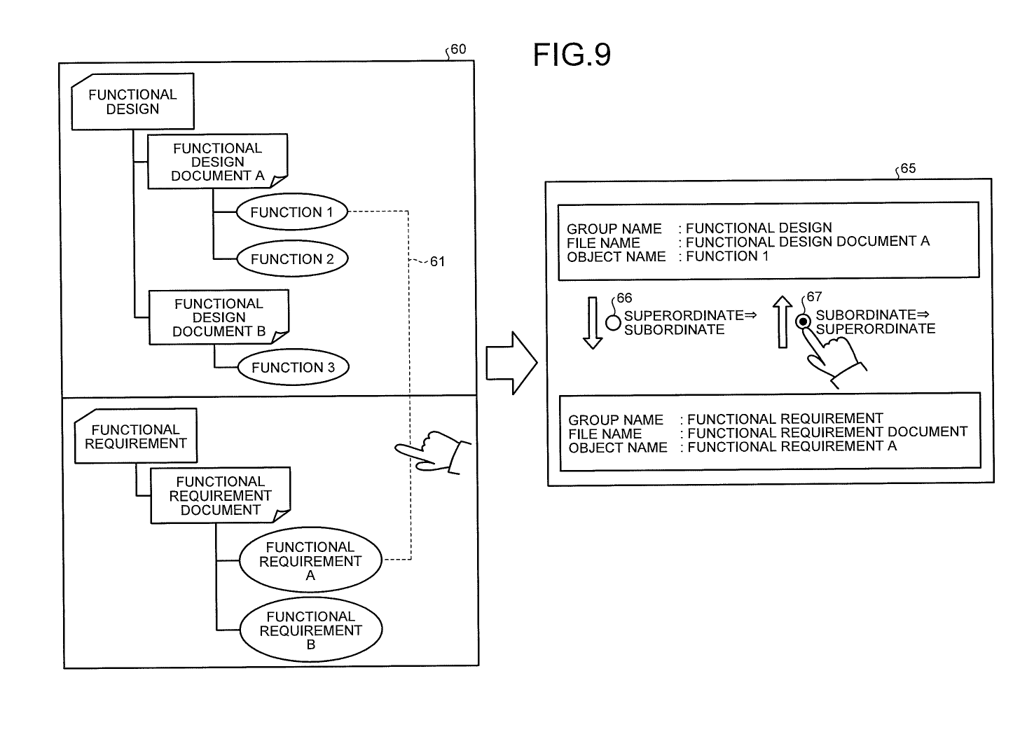

FIG. 9 is a diagram illustrating an example of the designation screen. As illustrated in FIG. 9, a designation screen 60 displays separate folders for different types of documents, and displays registered documents and elements of the documents in a tree structure. In the example in FIG. 9, the designation screen 60 displays a folder for a functional design and a folder for a functional requirement. Furthermore, the designation screen 60 displays a functional design document A and a functional design document B as registered documents for the functional design, and displays a functional requirement document as a registered document for the functional requirement. Moreover, the designation screen 60 displays a function 1 and a function 2 extracted as elements of the functional design document A, displays a function 3 extracted as an element of the functional design document B, and displays a functional requirement A and a functional requirement B extracted as elements of the functional requirement document. In the example in FIG. 9, it is determined that the function 1 of the functional design document A and the functional requirement A of the functional requirement document are related to each other. The designation screen 60 displays a dashed line 61 indicating that the function 1 of the functional design document A and the functional element A of the functional requirement document are related to each other and they are candidate elements to be associated with each other. When associating the elements displayed as the candidate elements to be associated, a developer designates the dashed line 61. The associating unit 42 reads pieces of information stored in the item of Key of the elements designated to be associated, and registers the read pieces of the information on the elements in the relation information 34 in an associated manner. Incidentally, the dependency relationship between the elements to be associated may be set such that the element of the document generated by an upstream process in the development flow serves as a superordinate element, and the element of the document generated in a downstream process serves as a subordinate element. For example, process information indicating types of documents generated in sequence in the development flow may be stored in the storage unit 23. The associating unit 42 may determine the dependency relationship between the elements to be associated based on the process information stored in the storage unit 23. Alternatively, a developer may designate the dependency relationship between the elements to be associated via a screen. For example, as illustrated in FIG. 9, if the elements to be associated are designated via the designation screen 60, a designation screen 65 for designating a dependency relationship may be displayed to enable to designate the dependency relationship via the designation screen 65. As illustrated in FIG. 9, the designation screen 65 contains radio buttons 66 and 67 for designating a dependency relationship between elements. The radio button 66 indicates that the function 1 of the functional design document A serves as a superordinate element and the functional requirement A of the functional requirement document serves as a subordinate element. The radio button 67 indicates that the function 1 of the functional design document A serves as a subordinate element and the functional requirement A of the functional requirement document serves as a superordinate element. The developer selects one of the radio buttons 66 and 67 in the designation screen 65 according to the dependency relationship used for the registration. The associating unit 42 associates the elements according to the dependency relationship selected via the designation screen 65.

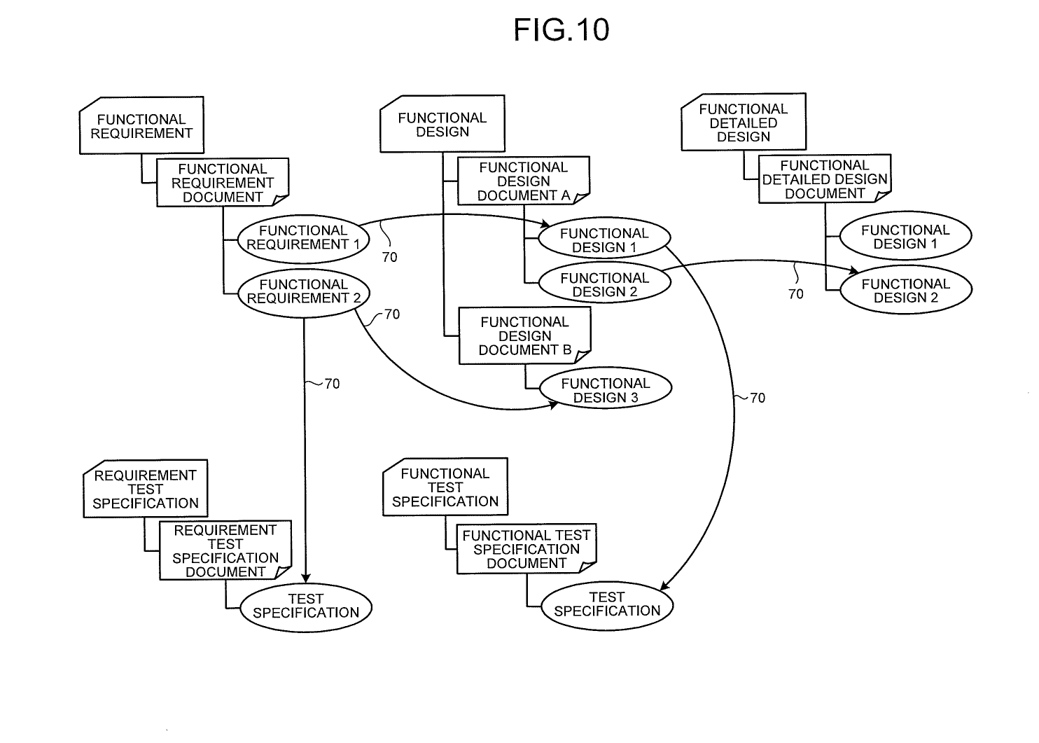

An example of association between various documents generated during development will be described below. FIG. 10 is a diagram illustrating an example in which various documents are associated with one another. In the example in FIG. 10, separate folders are provided for different types of documents, and registered documents and elements of the documents are provided in a tree structure. In the example in FIG. 10, folders are provided for a functional requirement, a functional design, a functional detailed design, a functional test specification, and a requirement test specification. Furthermore, in the example in FIG. 10, the functional requirement document is provided as a document of the functional requirement, the functional design document A and the functional design document B are provided as documents of the functional design, a functional detailed design document is provided as a document of the functional detailed design, a functional test specification document is provided as a document of the functional test specification, and a requirement test specification document is provided as a document of the requirement test specification. Moreover, in the example in FIG. 10, a functional requirement 1 and a functional requirement 2 are provided as elements of the functional requirement document, a functional design 1 and a functional design 2 are provided as elements of the functional design document A, a functional design 3 is provided as an element of the functional design document B, a detailed design 1 and a detailed design 2 are provided as elements of the functional detailed design document, a test specification is provided as an element of the functional test specification document, and a test specification is provided as an element of the requirement test specification document. In the example in FIG. 10, the associated elements are connected by relations 70. In the example in FIG. 10, the functional requirement 1 of the functional requirement document and the functional design 1 of the functional design document A are associated with each other. Furthermore, the functional requirement 2 of the functional requirement document and the functional design 3 of the functional design document B are associated with each other. Moreover, the functional design 2 of the functional design document A and the detailed design 2 of the functional detailed design document are associated with each other. Furthermore, the functional design 1 of the functional design document A and the test specification of the functional test specification document are associated with each other. Moreover, the functional requirement 2 of the functional requirement document and the test specification of the requirement test specification document are associated with each other.

The documents generated through the development contain a large number of various types of information, and multiple description formats are employed. Therefore, it takes effort and time for a developer to search for an item to be managed. Furthermore, a large number of documents are generated through the development. Therefore, it is difficult for the developer to manage association between items of the documents.

Therefore, the file management apparatus 11 stores, in the format information 31, pieces of information on elements to be associated in table-format files, for each of the description formats of documents. If a document is registered, the file management apparatus 11 extracts elements from the document based on the format of the registered document. Therefore, the file management apparatus 11 can extract pieces of information on the elements to be associated from among a large number of pieces of information contained in the documents. Furthermore, the file management apparatus 11 compares the pieces of the information on the extracted elements to determine a relevance. Therefore, the file management apparatus 11 can specify related elements from among a large number of the extracted elements, and therefore can assist the association operation.

Referring back to FIG. 2, the searching unit 43 performs various searches. For example, the searching unit 43 receives a search request for an area to be influenced, together with designation of an element of a document. For example, the searching unit 43 displays a condition screen for designating a search condition on the terminal device 12, and receives a search request for an area to be influenced via the condition screen.

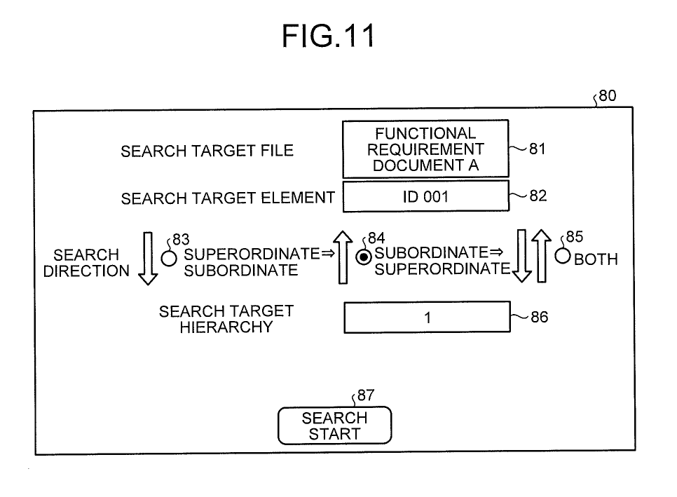

FIG. 11 is a diagram illustrating an example of the condition screen. A condition screen 80 includes an input field 81 for designating a file that serves as a search start point and an input field 82 for designating an element that serves as a search start point. In the input field 81, a file that serves as the search start point is input. In the input field 82, an element that serves as the search start point is input. Incidentally, it may be possible to display candidate files and elements in the input field 81 and the input field 82 such that a file and an element can be designated by selection. For example, files registered in the file information 33 are displayed in the input field 81. Then, pieces of attribute information on elements registered in the file information 33 are displayed in the input field 82, and, if a file is selected in the input field 81, pieces of attribute information on elements contained in the selected file are displayed. Furthermore, the condition screen 80 includes radio buttons 83, 84, and 85 for designating a dependency relationship between search target elements. The radio button 83 indicates a search for elements that are associated with a search target element based on a superordinate-to-subordinate dependency relationship in which the search target element serves as a superordinate element. The radio button 84 indicates a search for elements that are associated with the search target element based on a subordinate-to-superordinate dependency relationship in which the search target element serves as a subordinate element. The radio button 85 indicates a search for elements that are associated with the search target element based on any of the dependency relationships. Moreover, the condition screen 80 includes an input field 86 for designating the number of hierarchies to be employed as a search scope. If a large number of elements are associated with one another, in some cases, the search target element may be associated with other elements in a hierarchical manner; for example, elements associated with the search target element may be associated with other elements, and the other elements may be associated with still other elements. In the input field 86, the number of hierarchies with respect to the search target element is designated as a search scope of associated elements. For example, if a single hierarchy is designated, elements directly associated with the search target element serve as a search scope. Incidentally, in the condition screen 80 of the first embodiment, it may be possible to leave the input field 86 blank to refrain from designating the number of hierarchies. The condition screen 80 includes a button 87 for designating a start of a search. A developer designates a file and an element each serving as a search start point, the dependency relationship of the search target element, and the search scope, and then designates the button 87 to request a search via the condition screen 80.

The searching unit 43 searches for various types of information and extracts the information obtained by the search. For example, if a search is requested, the searching unit 43 searches for elements associated with the designated element in the relation information 34 according to the search condition designated via the condition screen 80. For example, in the relation information 34, information for specifying a first portion of a file in a first table format and information for specifying a second portion of a file in a second table format are associated with each other. In this case, when receiving a search request for an area to be influenced by the first portion, the searching unit 43 extracts the information for specifying the second portion associated with the information for specifying the first portion. Furthermore, if the search condition contains information for designating a dependency relationship, the searching unit 43 extracts information related to the first portion according to the information for designating the dependency relationship. For example, if the dependency relationship between search target elements is designated in the search condition, the searching unit 43 searches for elements that are associated based on the designated dependency relationship. Moreover, if the search condition contains information for designating a search scope of information on an associated portion, the searching unit 43 extracts associated information within the designated scope. For example, if the number of hierarchies is designated as a search scope of information on an associated portion, the searching unit 43 repeats extraction of the second portion associated with the first portion by assuming that the extracted second portion serves as the first portion, for the same number of times as the designated number of hierarchies.

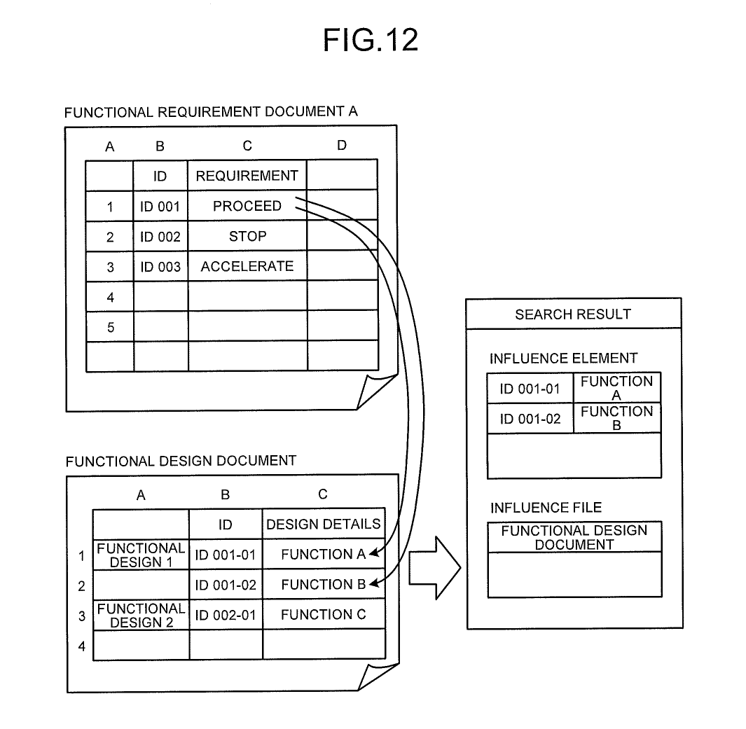

FIG. 12 is a diagram illustrating an example of the flow to search for an area to be influenced. In the example in FIG. 12, a requirement of “proceed” is written for an ID of “ID 001” in the functional requirement document A. Furthermore, a requirement of “stop” is written for an ID of “ID 002”, and a requirement of “stop” is written for an ID of “ID 003”. Moreover, in the example in FIG. 12, design details of “function A” is written for an ID of “ID 001-01” of the functional design 1 in the functional design document. Furthermore, design details of “function B” is written for an ID of “ID 001-02”, and design details of “function C” is written for an ID of “ID 002-01” of the functional design 2. In the example in FIG. 12, “function A” and “function B” are associated with the requirement of “proceed”. When receiving a search request for an area to be influenced, together with designation of a requirement, the searching unit 43 searches for requirements associated with the designated requirement, and outputs the requirement obtained by the search and files containing the requirements obtained by the search, as the area to be influenced. In the example in FIG. 12, when receiving a search request for an area to be influenced by the requirement of “proceed” of the functional design document, the searching unit 43 outputs, on a search result display screen, “function A”, “function B”, and the functional design document containing “function A” and “function B”, as the area to be influenced.

Incidentally, in the development of an automobile, the International Organization for Standardization (ISO) 26262 is defined as an automotive functional safety standard. The file management apparatus 11 extracts elements to be associated from registered documents, and manages the elements in an associated manner. Therefore, even if any of the elements need to be modified, it is possible to specify an area to be influenced by the modified element. Consequently, the file management apparatus 11 can support development compliant with ISO 26262.

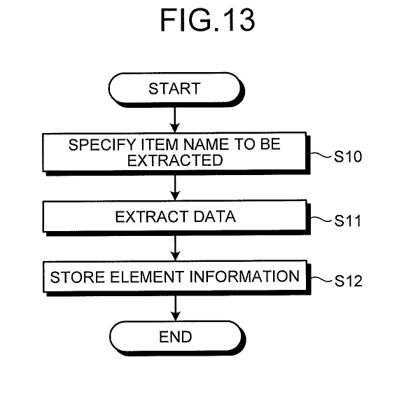

The flow of an extraction process for extracting an element from a document by the file management apparatus 11 according to the first embodiment will be explained below. FIG. 13 is a flowchart illustrating the flow of the extraction process. The extraction process is performed at a timing at which, for example, a document is registered in a folder for receiving registration of the document. Incidentally, the extraction process may be performed at regular time intervals by batch processing. Furthermore, the extraction process may be performed at a timing designated by an administrator.

As illustrated in FIG. 13, the extracting unit 40 specifies an item name of attribute information to be extracted and an item name of a cell in which information on an element is written, from the format information 31 based on the description format of the registered document (S10). The extracting unit 40 extracts data of the item of the item name designated as an extraction object from the registered file (S11). The extracting unit 40 assigns a unique ID number to the extracted attribute information and the extracted information on the element corresponding to the attribute information, and stores the ID number in association with the attribute information and the information on the element corresponding to the attribute information in the element information 32 (S12), and then the process is terminated.

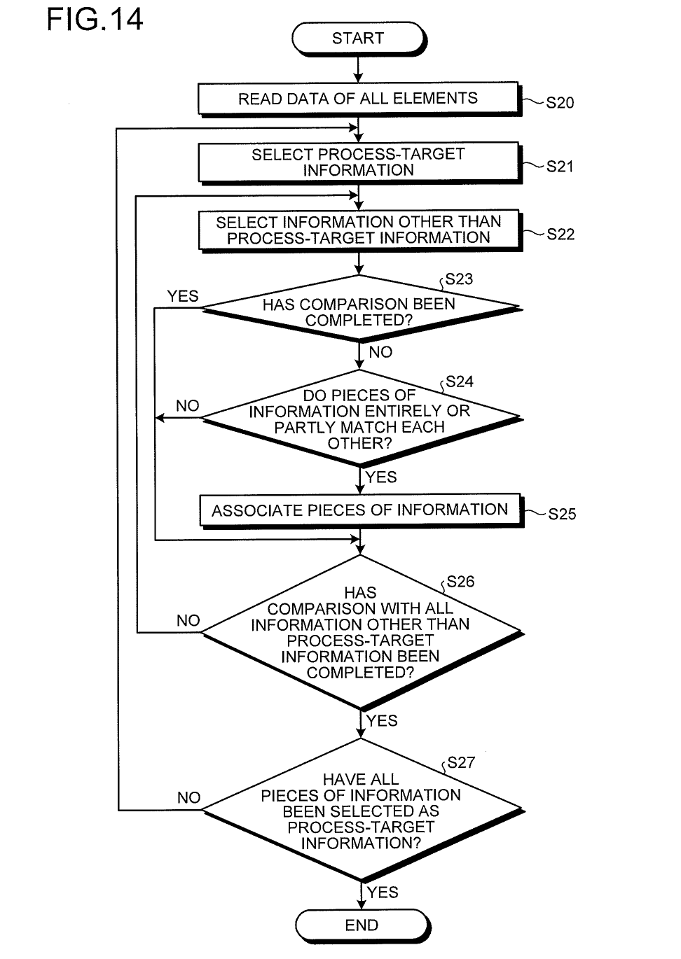

Next, the flow of an association process for associating elements by the file management apparatus 11 according to the first embodiment will be explained below. FIG. 14 is a flowchart illustrating the flow of the association process. The association process is performed at a timing at which, for example, the extraction process is completed. Incidentally, the association process may be performed at regular time intervals by batch processing or the like. Furthermore, the association process may be performed at a timing designated by an administrator.

As illustrated in FIG. 14, the determining unit 41 reads pieces of information stored in the item of Key from the element information 32 (S20). The determining unit 41 selects, as process-target information, a piece of information that has not been selected as the process-target information from among the read pieces of the information (S21). The determining unit 41 sequentially selects pieces of information other than the process-target information from among the read pieces of the information (S22). The determining unit 41 determines whether the process-target information and the selected information have been compared with each other (S23). If the comparison has been completed (YES at S23), the process proceeds to S26 to be described later.

In contrast, if the comparison has not been completed (NO at S23), the determining unit 41 compares the process-target information and the selected information to determine whether the pieces of the information entirely or partially match each other (S24). If the pieces of the information do not entirely or partially match each other (NO at S24), the process proceeds to S26 to be described later.

In contrast, if the pieces of the information entirely or partially match each other (YES at S24), the associating unit 42 reads pieces of information stored in the item of Key of the elements for which the pieces of the information entirely or partially match each other, and registers the read pieces of the information on the elements in the relation information 34 in an associated manner (S25).

The determining unit 41 determines whether the process-target information has been compared with all of the read pieces of the information other than the process-target information (S26). If the comparison has not been completed (NO at S26), the process proceeds to S22 as described above, and a next piece of information is selected.

In contrast, if the comparison has been completed (YES at S26), the determining unit 41 determines whether all of the read pieces of the information have already been selected as the process-target information (S27). If there is a piece of information that has not been selected as the process-target information from among the read pieces of the information (NO at S27), the process proceeds to S21 as described above.

In contrast, if all of the read pieces of the information have been selected as the process-target information (YES at S27), the process is terminated.

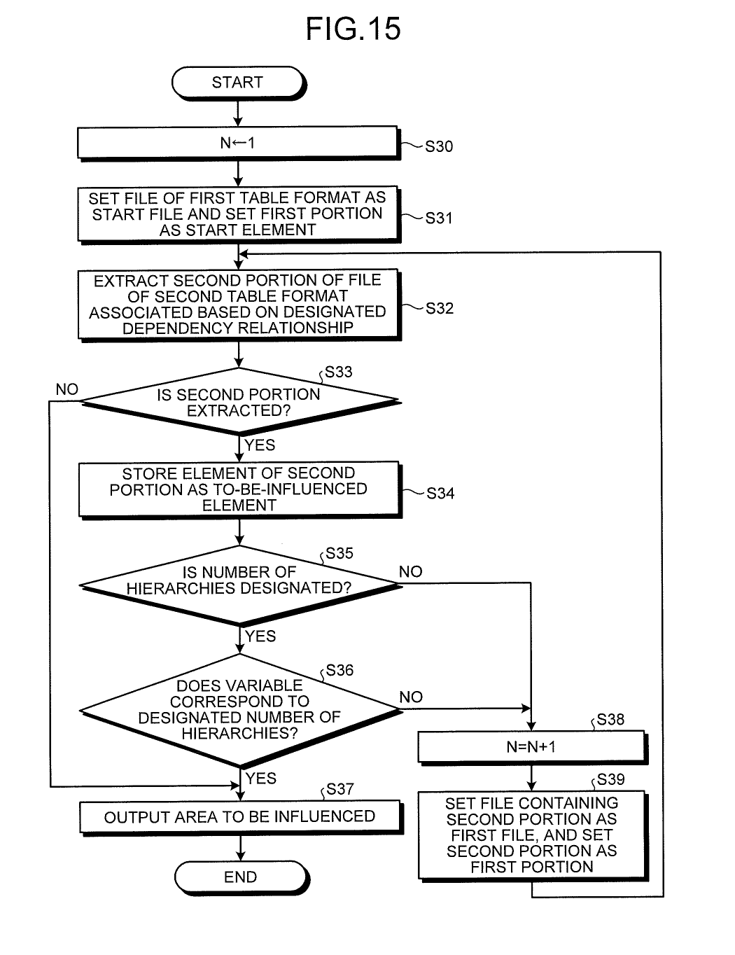

Next, the flow of a search process performed by the file management apparatus 11 according to the first embodiment to search for an area to be influenced will be explained below. FIG. 15 is a flowchart illustrating the flow of the search process. The search process is performed at a timing at which, for example, a search request is received.

As illustrated in FIG. 15, the searching unit 43 sets a variable N to one indicating a hierarchy subjected to a search (S30). The searching unit 43 sets a file in a first table format as a file serving as the search start point designated in the search condition, and sets a first portion as an element serving as the search start point (S31).

The searching unit 43 extracts a second portion of a file in a second table format associated with the first portion of the file in the first table format based on the dependency relationship designated in the search condition (S32). For example, if a search based on the superordinate-to-subordinate dependency relationship is designated, the searching unit 43 extracts, from the relation information 34, a subordinate element of an element of the first portion of the file in the first table format serving as a superordinate element. For example, the searching unit 43 searches for attribute information in the item of Relation Child ID of a record, for which the attribute information on the element of the first portion of the file in the first table format is stored in the item of Relation Parent ID in the relation information 34. Furthermore, if a search based on the subordinate-to-superordinate dependency relationship is designated, the searching unit 43 extracts, from the relation information 34, a superordinate element that is associated with the element of the first portion of the file in the first table format serving as a subordinate element. For example, the searching unit 43 searches for attribute information in the item of Relation Parent ID of a record, for which the attribute information on the element of the first portion of the file in the first table format is stored in the item of Relation Child ID in the relation information 34. Then, the searching unit 43 handles the extracted element as the second portion of the file in the second table format.

The searching unit 43 determines whether the second portion of the file in the second table format is extracted (S33). If the second portion is not extracted (NO at S33), the process proceeds to S37 to be described later.

In contrast, if the second portion is extracted (YES at S33), an element of the second portion of the file in the second table format is stored as an element to be influenced (S34).

The searching unit 43 determines whether the number of hierarchies is designated in the search condition (S35). If the number of hierarchies is designated (YES at S35), the searching unit 43 determines whether the variable N indicating the hierarchy subjected to the search corresponds to the number of hierarchies designated in the search condition (S36). If the variable N corresponds to the number of hierarchies designated in the search condition (YES at S36), the searching unit 43 outputs the above-stored element to be influenced and a file containing the element to be influenced, as an area to be influenced (S37), and the process is terminated.

In contrast, if the number of hierarchies is not designated (NO at S35) or if the variable N does not correspond to the number of hierarchies designated by the search condition (NO at S36), the process proceeds to S38 to be described below. The searching unit 43 adds one to the value of the variable N (S38). Then, the searching unit 43 sets the second portion obtained by the search as a new first portion, and sets a file in the second table format containing the second portion as a new file in the first table format (S39), and then the process proceeds to S32 as described above.

As described above, the file management apparatus 11 stores an association relationship between the information for specifying the first portion of the file in the first table format and the information for specifying the second portion of the file in the second table format in the relation information 34 in the storage unit 23. When receiving a search request for an area to be influenced by the first portion of the file in the first table format, the file management apparatus 11 extracts information for specifying the second portion associated with the information for specifying the first portion, by referring to the relation information 34 in the storage unit 23. Then, the file management apparatus 11 outputs, as a reply to the search request, information for specifying the second portion and information for specifying the file in the second table format containing the second portion. Therefore, the file management apparatus 11 can specify even a portion of a file as an area to be influenced by a modification.

Furthermore, the file management apparatus 11 stores, in the relation information 34 in the storage unit 23, the dependency relationship of the second portion with respect to the first portion. Then, if the search request for the area to be influenced contains information for designating the dependency relationship, the file management apparatus 11 extracts information related to the first portion according to the information for designating the dependency relationship. Therefore, the file management apparatus 11 can extract only a portion that is associated based on a specific dependency relationship. For example, if the dependency relationship is the order of development processes, the file management apparatus 11 can extract portions to be influenced in subsequent processes.

Moreover, if the search request for the area to be influenced contains information for designating a search scope, the file management apparatus 11 extracts information for specifying the second portion associated with the first portion within the scope contained in the search request. Therefore, the file management apparatus 11 can extract an area to be influenced by a modification within the designated scope.

### [b] Second Embodiment

A second embodiment will be explained below. A configuration of the file management apparatus 11 according to the second embodiment is approximately the same as the file management apparatus 11 according to the first embodiment illustrated in FIG. 2; therefore, differences will be mainly explained below.

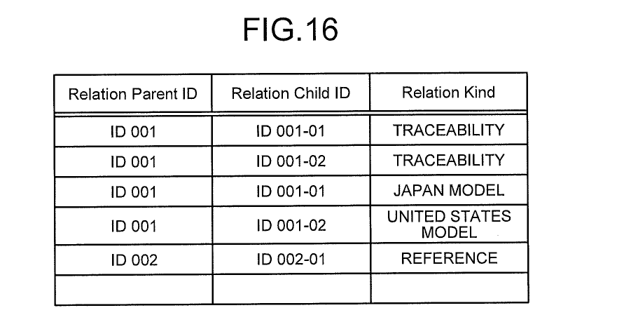

The file management apparatus 11 according to the second embodiment is able to set a type of an association relationship between elements. Furthermore, the file management apparatus 11 is able to set multiple types of association relationships between the same elements. The file management apparatus 11 stores a type of an association relationship in the relation information 34 for each of association relationships. FIG. 16 is a diagram illustrating an example of a data structure of the relation information. Incidentally, explanation of the same components as those of the relation information 34 of the first embodiment illustrated in FIG. 6 will be omitted, and differences will be mainly explained below. As illustrated in FIG. 16, the relation information 34 according to the second embodiment further contains an item of “Relation Kind”. The item of Relation Kind is a field for storing information indicating a type of an association relationship employed for association.

Incidentally, elements extracted from documents are associated with one another for various purposes. For example, elements to be influenced by a modification are associated with each other to simplify a search for the area to be influenced by the modification. Furthermore, elements concerning a part developed for a specific target are associated with each other. For example, in the development of an automobile, different functions may be developed for different countries in order to comply with respective legal systems, environments, or needs in the countries. Moreover, elements of a referenced part are associated with each other in order to simplify a search for the referenced part in the documents.

The file management apparatus 11 according to the second embodiment can register different types of association relationships for respective purposes, and provides items of “Traceability”, “Japan Model”, “United States Model”, and “Reference” as types of association relationships. The item of Traceability is used to associate elements to be influenced by a modification. The item of Japan Model is used to associate elements of specific functions developed for Japan. The item of United States Model is used to associate elements of specific functions developed for the United States. The item of Reference is used to associate elements of referenced documents.

In the item of Relation Kind in the relation information 34 according to the second embodiment, a name indicating a type is stored as information on the type of the association relationship. In the example in FIG. 16, an element of “ID 001” and an element of “ID 001-01” are associated with “Traceability”. Furthermore, the element of “ID 001” and the element of “ID 001-01” are also associated with “Japan Model”. The element of “ID 001” and an element of “ID 001-02” are associated with “Traceability”. Furthermore, the element of “ID 001” and the element of “ID 001-01” are also associated with “United States Model”. An element of “ID 002” and an element “ID 002-01” are associated with “Reference”.

The file management apparatus 11 displays, as candidate elements, elements determined as related elements by the determining unit 41 on the designation screen 60 illustrated in FIG. 9, and receives designation of elements to be associated. Then, when the elements to be associated are designated via the designation screen 60, the file management apparatus 11 displays the designation screen 65 for designating a dependency relationship, and receives designation of the dependency relationship and a type via the designation screen 65.

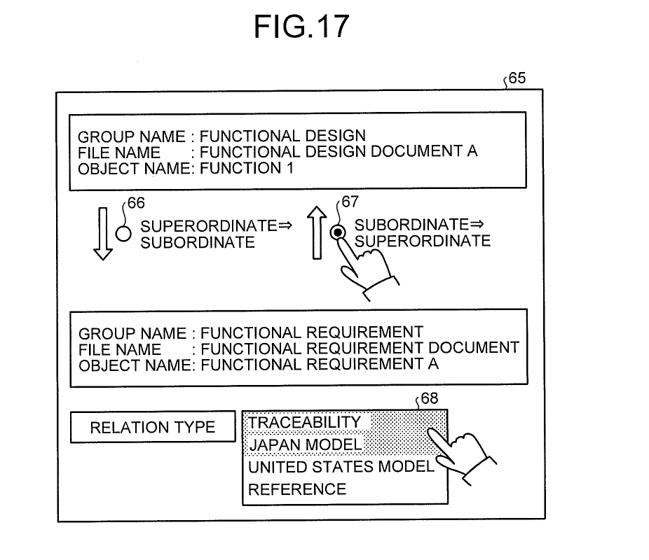

FIG. 17 is a diagram illustrating an example of the designation screen. Incidentally, explanation of the same components as those of the designation screen 65 of the first embodiment illustrated in FIG. 9 will be omitted, and differences will be mainly explained below. As illustrated in FIG. 17, the designation screen 65 according to the second embodiment includes a selection area 68 for designating a type of a dependency relationship between elements. The selection area 68 displays names of types of available association relationships to enable to select a type. In the example in FIG. 17, “Traceability”, “Japan Model”, “United States Model”, and “Reference” are displayed in the selection area 68 to enable to select a type. In the selection area 68, multiple types may be selected simultaneously. In the selection area 68, the selected item is displayed in a highlighted manner. When associating elements to be influenced by a modification, a developer selects “Traceability”. Furthermore, when associating elements of specific functions developed for Japan, the developer selects “Japan Model”. Moreover, when associating elements of specific functions developed for the United States, the developer selects “United States Model”. Furthermore, when associating elements of referenced documents, the developer selects “Reference”. In the example in FIG. 17, “Traceability” and “Japan Model” are selected.

The associating unit 42 registers the elements, which are designated to be associated via the designation screen, in the relation information 34 for each of the types designated in the designation screen 65.

Furthermore, the file management apparatus 11 according to the second embodiment allows the developer to designate elements to be associated and associate the elements via an operation screen. When receiving a request for the operation screen from the terminal device 12, the associating unit 42 displays the operation screen to associate elements on the terminal device 12, and associates the elements designated via the operation screen.

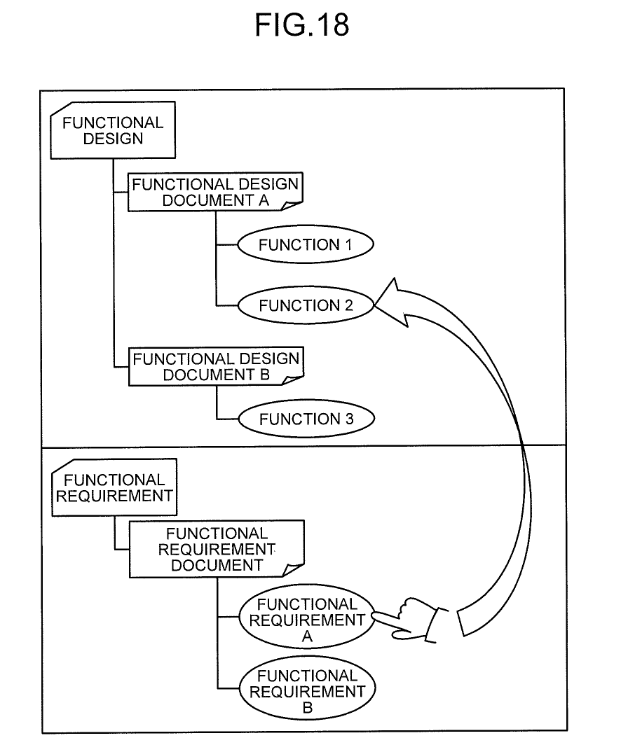

FIG. 18 is a diagram illustrating an example of the operation screen. As illustrated in FIG. 18, an operation screen 90 according to the second embodiment displays separate folders for different types of documents, and displays registered documents and elements of the documents in a tree structure. In the example in FIG. 18, the operation screen 90 displays a folder for a functional design and a folder for a functional requirement. Furthermore, the operation screen 90 displays a functional design document A and a functional design document B as registered documents for the functional design, and displays a functional requirement document as a registered document for the functional requirement. Moreover, the operation screen 90 displays the function 1 and the function 2 extracted as elements of the functional design document A, displays the function 3 extracted as an element of the functional design document B, and displays the functional requirement A and the functional requirement B extracted as elements of the functional requirement document. The operation screen 90 receives designation of elements to be associated with each other. For example, the operation screen 90 receives designation of elements to be associated with each other by drag-and-drop of one element to the other element to be associated. In the example in FIG. 18, the functional requirement A is dragged and dropped on the function 2 in order to associate the functional requirement A of the functional requirement document with the function 2 of the functional design document A.

When the elements to be associated are designated via the operation screen 90, the associating unit 42 displays the designation screen 65 as illustrated in FIG. 17 and receives designation of a dependency relationship and designation of a type via the designation screen 65. Then, the associating unit 42 registers the elements, which are designated to be associated via the operation screen 90, in the relation information 34 according to the dependency relationship and the type designated via the designation screen 65. Incidentally, when the operation screen 90 receives designation of elements to be associated by drag-and-drop, the associating unit 42 may associate the elements such that, for example, the dragged element serves as a superordinate element in the dependency relationship and the element onto which the dragged element is dropped serves as a subordinate element in the dependency relationship.

Furthermore, the file management apparatus 11 according to the second embodiment receives a search request for an area to be influenced, together with designation of an association type to be searched for. For example, the searching unit 43 displays, as a search condition, a condition screen containing a field that enables to designate an association type to be searched for on the terminal device 12, and receives the search request for the area to be influenced via the condition screen.

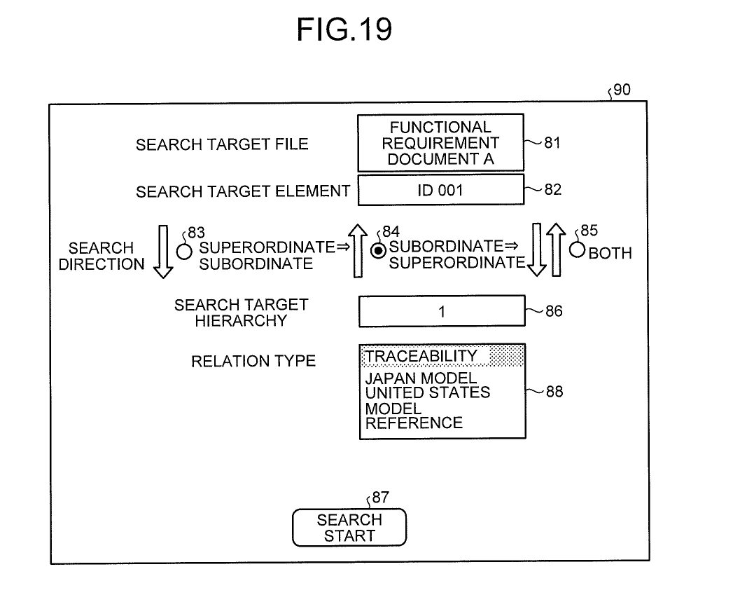

FIG. 19 is a diagram illustrating an example of the condition screen. Incidentally, explanation of the same components as those of the condition screen 80 according to the first embodiment illustrated in FIG. 11 will be omitted, and differences will be mainly explained below. As illustrated in FIG. 19, the condition screen 80 according to the second embodiment includes a selection area 88 for designating an association type to be searched for. The selection area 88 displays names of types of available association relationships to enable to select a type. In the example in FIG. 19, “Traceability”, “Japan Model”, “United States Model”, and “Reference” are displayed in the selection area 88 to enable to select a type. In the selection area 88, multiple types may be selected simultaneously. In the selection area 88, the selected item is displayed in a highlighted manner. When searching for an element to be influenced by a modification, a developer selects “Traceability”. Furthermore, when searching for an element of a specific function developed for Japan, the developer selects “Japan Model”. Moreover, when searching for an element of a specific function developed for the United States, the developer selects “United States Model”. Furthermore, when searching for an element of a referenced document, the developer selects “Reference”. In the example in FIG. 19, “Traceability” is selected.

When a search is requested, the searching unit 43 searches for, as the area to be influenced, elements associated with the designated element in the relation information 34 according to the search condition designated via the condition screen 80. For example, in the relation information 34, the information for specifying the first portion of the file in the first table format and the information for specifying the second portion of the file in the second table format are associated with each other. In this case, if the search condition contains information for designating a type of an association relationship, the searching unit 43 extracts information for specifying a second portion that is associated based on the designated type, from among second portions associated with the information for specifying the first portion.

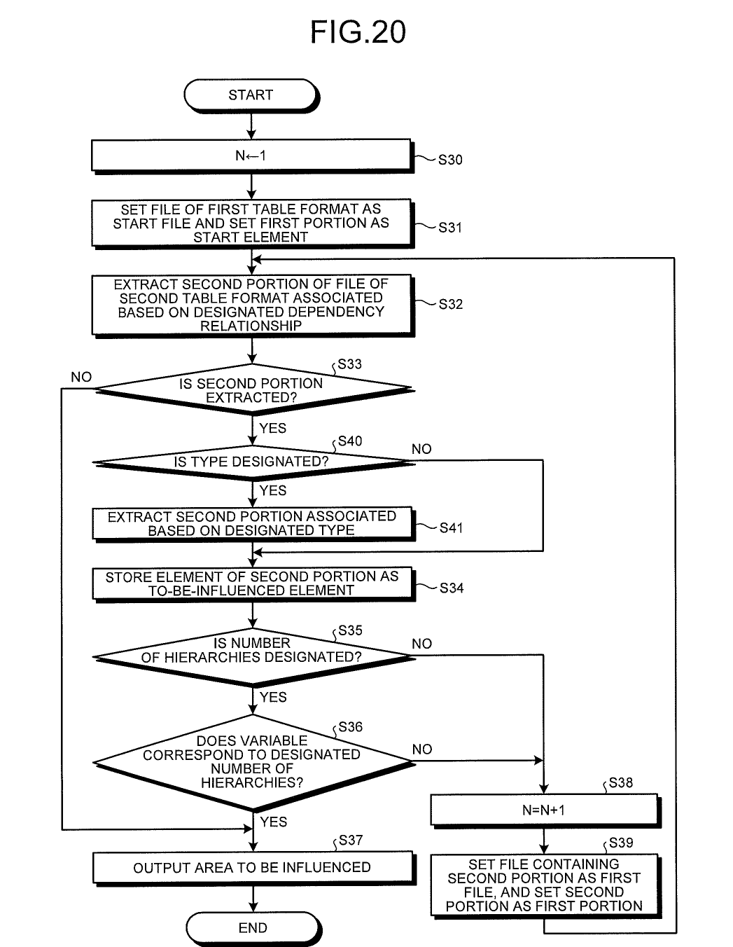

The flow of a search process performed by the file management apparatus 11 according to the second embodiment to search for an area to be influenced will be explained below. FIG. 20 is a flowchart illustrating the flow of the search process. Incidentally, explanation of the same processes as those of the search process according to the first embodiment illustrated in FIG. 15 will be omitted, and differences will be mainly explained below.

The searching unit 43 determines whether a type of an association relationship is designated in the search condition (S40). If the type is not designated (NO at S40), the process proceeds to S34 as described above. In contrast, if the type is designated (YES at S40), the searching unit 43 extracts an element of the second portion that is associated based on the designated type, from among elements of the second portion of the file in the second table format extracted by the process at S32 (S41), and the process proceeds to S34.

As described above, the file management apparatus 11 further stores a type of an association relationship in the relation information 34 in the storage unit 23, for each of association relationships. If a search request for an area to be influenced contains information for designating a type of an association relationship, the file management apparatus 11 extracts information for specifying the second portion that is associated based on the type contained in the search request, from among the second portions associated with the information for specifying the first portion. Therefore, the file management apparatus 11 can extract only a portion that is associated based on a specific type. For example, the file management apparatus 11 can specify even a portion of a file as the area to be influenced by a modification. Furthermore, the file management apparatus 11 can specify even a portion of a file as an area corresponding to the development for a specify country, such as Japan or the United States. Moreover, the file management apparatus 11 can specify even a portion of a file of a referenced document.

### [c] Third Embodiment

While the embodiments of the present invention have been described above, the present invention may be embodied in various forms other than the above-described embodiments. The other embodiments will be described below.

For example, while, in the embodiments, an example has been explained in which item names of elements to be associated are stored and pieces of data of the items of the item names are extracted as information on the elements, the present invention is not limited to this example. For example, it may be possible to store area information indicating an area in which information on elements to be associated is stored, and may extract data in the area indicated by the area information in a file.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. For example, the processing units of the extracting unit 40, the determining unit 41, the associating unit 42, and the searching unit 43 illustrated in FIG. 2 may be integrated or separated appropriately. Furthermore, for each processing function performed by each processing unit, all or any part of the processing function may be implemented by a CPU and a program analyzed and executed by the CPU or may be implemented as hardware by wired logic.

File Management Program

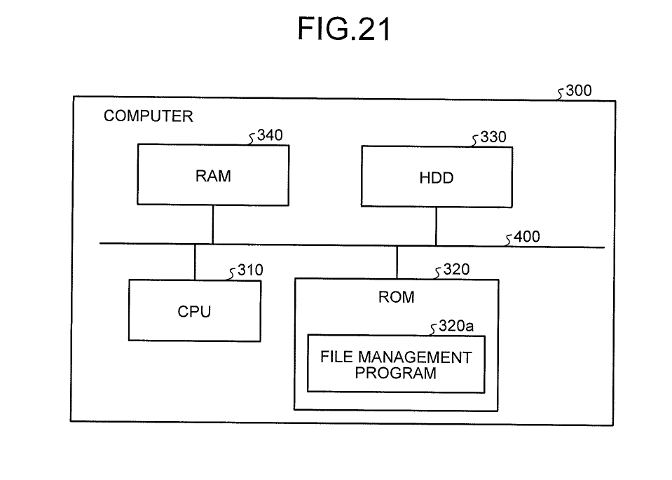

Various processes explained in the above embodiments may be implemented by causing a computer system, such as a personal computer or a workstation, to execute a program that is prepared in advance. Therefore, an example of the computer system that executes a program having the same functions as those of the embodiments will be explained below. FIG. 21 is a diagram illustrating a computer that executes a file management program.

As illustrated in FIG. 21, a computer 300 includes a CPU 310, a read only memory (ROM) 320, a hard disk drive (HDD) 330, and a RAM 340. The units 310 to 340 are connected to one another via a bus 400.

The ROM 320 stores therein, in advance, a file management program 320a that implements the same functions as those of the processing units of the above embodiments. For example, the file management program 320a implements the same functions as those of the extracting unit 40, the determining unit 41, the associating unit 42, and the searching unit 43 of the above embodiments. Meanwhile, the file management program 320a may be separated appropriately.

The HDD 330 stores therein various types of data. For example, the HDD 330 stores therein an OS or various types of data used to manage files.

The CPU 310 reads the file management program 320a from the ROM 320 and executes the program, to thereby implement the same operations as those of the processing units of the embodiments. Specifically, the file management program 320a implements the same operations as those of the extracting unit 40, the determining unit 41, the associating unit 42, and the searching unit 43 of the embodiments.

Incidentally, the file management program 320a described above need not always be stored in the ROM 320 from the beginning. The file management program 320a may be stored in the HDD 330.

For example, the program may be stored in a “portable physical medium”, such as a flexible disk (FD), a compact disk-ROM (CD-ROM), a digital versatile disk (DVD), a magnetooptical disk, or an integrated circuit (IC) card, that is insertable into the computer 300. Then, the computer 300 reads the program from the medium and executes the program.

Alternatively, the program may be stored in “other computers (or servers)” connected to the computer 300 via a public line, the Internet, a local area network (LAN), or a wide area network (WAN). Then, the computer 300 reads the program from the other computers or servers and executes the program.

It is possible to specify even a portion of a file as an area to be influenced by a modification.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a file management program for causing a computer to execute a process, the process comprising:
extracting, upon receiving a search request for an area to be influenced by a first portion of a file in a first table format, information for specifying a second portion of a file in a second table format associated with information for specifying the first portion, by referring to a storage unit containing an association relationship between the information for specifying the first portion and the information for specifying the second portion; and
outputting the information for specifying the second portion and information for specifying the file in the second table format containing the second portion, as a reply to the search request.

2. The non-transitory computer-readable recording medium according to claim 1, wherein
when the search request contains information for designating the dependency relationship, the extracting includes extracting, by referring to the storage unit that stores therein a dependency relationship of the second portion to the first portion, information on the first portion according to the information for designating the dependency relationship.

3. The non-transitory computer-readable recording medium according to claim 1, wherein when the search request contains information for designating a search scope of information on an associated portion, the extracting includes extracting information for specifying the second portion associated with the first portion within the search scope contained in the search request.

4. The non-transitory computer-readable recording medium according to claim 1, wherein
when the search request contains information for designating a type of the association relationship, the extracting includes extracting, by referring to the storage unit that further stores therein a type of an association relationship for each of association relationships, information for specifying the second portion that is associated based on the type contained in the search request, from among second portions associated with the information for specifying the first portion.

5. A file management apparatus comprising:
a storage unit that stores therein an association relationship between information for specifying a first portion of a file in a first table format and information for specifying a second portion of a file in a second table format; and
a control unit that extracts, upon receiving a search request for an area to be influenced by the first portion, the information for specifying the second portion associated with the information for specifying the first portion by referring to the storage unit, and outputs the information for specifying the second portion and information for specifying the file in the second table format containing the second portion as a reply to the search request.

6. A file management method performed by a computer, comprising:
extracting, by a computer, upon receiving a search request for an area to be influenced by a first portion of a file in a first table format, information for specifying a second portion of a file in a second table format associated with information for specifying the first portion, by referring to a storage unit containing an association relationship between the information for specifying the first portion and the information for specifying the second portion; and
outputting, by a computer, the information for specifying the second portion and information for specifying the file in the second table format containing the second portion, as a reply to the search request.
